(19) United States
(12) Patent Application Publication
(10) Pub. No.: US 2011/0013905 A1
(43) Pub. Date: Jan. 20, 2011

(54) ACTIVE OPTICAL CABLE APPARATUS AND METHOD FOR DETECTING OPTICAL FIBER BREAKAGE

(75) Inventors: Xiaozhong Wang, Sunnyvale, CA (US); Kit Man Cham, Cupertino, CA (US)

Correspondence Address: Kathy Manke;Avago Technologies Limited, 4380 Ziegler Road, Fort Collins, CO, 80525, US

(73) Assignee: AVAGO TECHNOLOGIES FIBER IP (SINGAPORE) PTE. LTD., Singapore (SG)

(21) Appl. No.: 12/504,846

(22) Filed: Jul. 17, 2009

(51) Int. Cl. H04B 10/08

(52) U.S. Cl. 398/21

(57) ABSTRACT

Embodiments of the invention include an active optical cable and method for controlling the operation of the active optical cable based on the detection of signal loss, e.g., due to fiber breakage, within the active optical cable. The active optical cable includes first and second optical transceivers, each with an open fiber control module coupled between the transmission side and the receiver side of the respective optical transceiver. The transmission side of each optical transceiver is coupled to the receiver side of the other optical transceiver via a plurality of transmission channels, such as a plurality of optical fibers. Each open fiber control module is configured to detect an optical power level of an optical signal received by the receiver side of the optical transceiver within which the open fiber control module resides and, based on such detection, control the operation of the corresponding transmission side of the optical transceiver.

### BACKGROUND OF THE INVENTION

1. Field of the Invention

The invention relates to active optical cables and systems including active optical cables. More particularly, the invention relates to active optical cable apparatus and methods that detect fiber breakage in an active fiber cable and reduce laser emissions resulting from the fiber breakage.

2. Description of the Related Art

Active optical cables increasingly are being used as an alternative to copper-based connector links, e.g., for data computing connections having data transmission requirements of 10 gigabit (Gbit) per second (Gbit/sec) or more. Conventionally, passive and active copper cabling has provided much of the connectivity between server-to-server and server-to-switch connections in many data computing systems. However, as data transmission rates approach 10 Gbit/sec, the data transfer qualities of copper cabling begins to suffer. Therefore, alternative connectivity solutions, such as active optical cables, are being used to replace many of the connector links within existing copper-based systems.

An active optical fiber cable typically includes an optical fiber cable, such as a fiber ribbon or strand, coupled between two optical transceivers. The transmitter portion of the optical transceivers couple or transmit laser emissions into the optical fiber cable for receipt by the receiver portion of the other optical transceiver. Each optical transceiver connects to the copper port of an existing system. Therefore, in this manner, active optical cables provide existing copper-based systems with the benefits of optical transmission at various locations throughout the transmission system.

With regard to safety concerns associated with active optical cables, the international safety standard IEC 60825 for optical transmission systems, as set forth by the International Electro-technical Commission, specifies that no more than a relatively safe level of laser emission from an active optical fiber cable be accessible by humans, i.e., be seen by human eye. Such safety standards apply to laser emissions coupled from the optical transceivers to the optical fiber cable during normal operations, as well as laser emissions resulting from a single fault condition. A single fault condition can include a cut or broken fiber in the optical fiber cable, the removal of a connector, and/or a malfunction in the active optical cable's driver integrated circuit (IC), firmware, assembly process or general operation.

During normal operating conditions, usually no laser emission coupled from the optical transceivers to the optical fiber cable is accessible by humans, although such coupling still needs to be carefully controlled to meet established IEC safety standards. However, when an optical fiber within the optical fiber cable is cut or broken, the laser emission resulting from the malfunction still needs to be at or below an eye-safe level to meet existing safety standards. Moreover, the permissible emission level is reduced for system configurations that include multiple laser emitters in parallel active optical cables, as well as configurations in which multiple optical fibers are arranged relatively close to one another within an active optical cable. Also, permissible emission levels are even further reduced for active optical cable arrangements having individual optical fibers in strand form and arranged in one of several geometric arrangements.

Conventionally, to meet such safety standards, optical power coupled into the fiber is attenuated by an appropriate amount so that if a fiber breakage occurs, the amount of optical power accessible by a human eye remains at or below a safe level. However, optical power attenuation in this manner severely limits the choice of optical source lasers, and expands the scope of testing and programming required by the optical cable manufacturing process.

Alternatively, components that limit the reflection of laser emissions to system feedback devices can be used to meet existing safety standards. However, such configurations can cause various system components to not be aware of optical power levels, which therefore can prevent proper response to an authentic fault condition.

Therefore, a need exists for an active optical cable apparatus and method for detecting breakage within an active optical cable and, upon detection of a breakage, taking appropriate action to ensure that laser emissions resulting from the breakage and accessible by the human eye remain at relatively safe levels according to established safety standards.

### SUMMARY OF THE INVENTION

The active optical cable apparatus and method involve controlling the operation of the active optical cable based on the detection of signal loss, e.g., due to fiber breakage, within the active optical cable. The active optical cable includes first and second optical transceivers, each optical transceiver with an open fiber control module or other appropriate configuration coupled between the transmission side and the receiver side of the respective optical transceiver. The transmission side of each optical transceiver is coupled to the receiver side of the other optical transceiver via a plurality of transmission channels, such as a plurality of optical fibers. Each open fiber control module is configured to detect the optical power level of optical signals received by the receiver side of the optical transceiver within which the open fiber control module resides and, based on such detection, control the operation of the corresponding transmission side of the optical transceiver. In this manner, if received power levels are reduced, e.g., because of a broken or damaged transmission channel between the optical transceivers, the open fiber control module can initiate the stoppage of data signal transmission from the transmitters within the active optical cable, and initiate polling signal transmission from the transmitters within the active optical cable. When the received power levels return to their normal operating levels, indicating that the transmission channel has been repaired, the open fiber control module can initiate the resumption of data signal transmission from the transmitters within the active optical cable.

### BRIEF DESCRIPTION OF THE DRAWINGS

FIG. 1 is a schematic view of a portion of a copper-based transmission system including an active optical cable, such as an active optical cable including an open fiber cable module for detecting fiber breakage in the active optical cable according to embodiments of the invention;

FIG. 2 is a schematic view of an active optical cable according to embodiments of the invention, including at least one open fiber cable module for detecting optical signal loss in the active optical cable; and

FIG. 3 is a block diagram of a method for detecting optical signal loss in an active optical cable according to embodiments of the invention.

### DETAILED DESCRIPTION

In the following description, like reference numerals indicate like components to enhance the understanding of the active optical cable apparatus and methods through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

Embodiments of the invention include an active optical cable having the ability to detect signal loss, e.g., due to fiber breakage, within the active optical cable, and to prevent excessive laser emission from the fiber breakage that is accessible by human eye. The active optical cable includes an open fiber control (OFC) module or other appropriate arrangement configured to detect fiber breakage based on the level of optical power received by the receiving side of the optical transceiver from each optical fiber (channel) in the active optical cable. Based on the detection of a reduced optical signal below a given level, the OFC module instructs the transmitter within the optical transceiver to stop transmitting or, alternatively, reducing transmission to a safe, low level. Once the transmitter stops its optical transmission, the OFC module in the optical transceiver at the other end of the active optical cable detects the halted optical transmission to its corresponding receiving side, and therefore instructs its corresponding transmitter to stop optical transmission as well. The OFC modules also are configured to instruct their respective optical transceiver to enter a polling state upon the detection of a reduced optical signal below a given level, or if the other end of the active optical cable is not powered up or has just been reset. In the polling state, the transmitter within the optical transceiver periodically transmits a polling signal and the OFC module monitors the receiver side within the optical transceiver for receipt of the transmitted polling signal within a given time period, thus indicating normal operation of the active optical cable. When its corresponding optical transceiver is in the polling state, the OFC module is configured to return transmit all received polling signals back to the optical transceiver from which the polling signal was received. The OFC module instructs the corresponding optical transceiver to return to its normal operating state only if, during the polling state, the OFC module determines that the other end of the active optical cable is operating normally, e.g., there is no fiber breakage between the two optical transceivers.

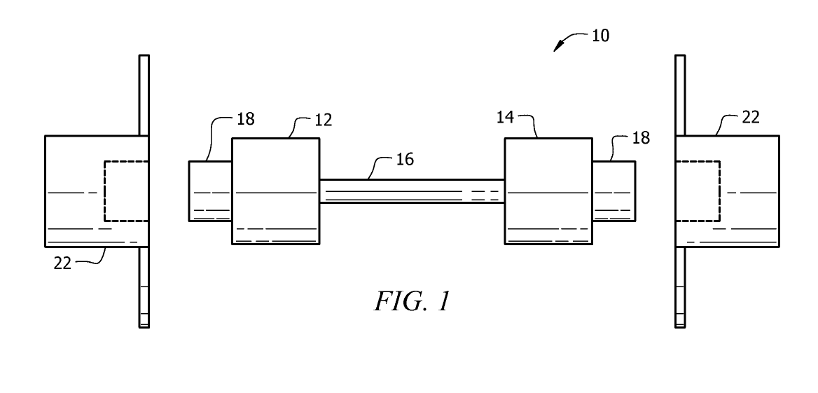

Referring now to FIG. 1, shown is a schematic view of an active optical cable 10 for use in a data transmission system, such as an otherwise copper-based transmission system. As will be discussed in greater detail hereinbelow, according to embodiments of the invention, the active optical cable 10 includes one or more open fiber control (OFC) modules or other appropriate configuration for detecting signal loss in the active optical cable, e.g., due to fiber breakage in the active optical cable, and controlling the operation of the active optical cable 10 in response to the detected signal loss and subsequent signal restoration.

The active optical cable 10 includes a first optical transceiver 12, a second optical transceiver 14 and an optical fiber arrangement 16 coupled between the first optical transceiver 12 and the second optical transceiver 14. The optical fiber arrangement 16 typically includes a plurality of optical fibers configured in a suitable optical fiber arrangement, such as parallel optical arrays within one or more stranded cables, or one or more optical fiber ribbons.

Each of the first optical transceiver 12 and the second optical transceiver 14 can include an appropriate electrical connection portion 18 for connecting the corresponding optical transceiver to a data transmission system port 22, such as a copper port, which may be part of an overall copper-based data transmission system. Each of the first optical transceiver 12 and the second optical transceiver 14 includes appropriate components to provide optical transmission therebetween and electro-optical conversion for appropriate interconnectivity with the corresponding data transmission system ports 22. Also, each of the first optical transceiver 12 and the second optical transceiver 14 can be configured as a quad small-form-factor pluggable (QSFP) transceiver or other appropriate transceiver configuration for interconnecting with the data transmission system ports 22.

Accordingly, within a given data transmission system, users can replace a pluggable copper-based transmission device with the active optical cable 10. The form factor of the active optical cable 10 mirrors that of the copper-based transmission device being replaced. To the data transmission line card at each end of the system where the active optical cable 10 is being plugged in, the end of the active optical cable 10 looks and acts just like a copper-based transmission device.

Typically, with the active optical cable 10, the optical fiber arrangement 16 comes “hard wired” to both the first optical transceiver 12 and the second optical transceiver 14, thus eliminating many of the obstacles that fiber optic connections have had in the past in similar applications. For example, with active optical cables, technicians do not have to worry about cleaning, splicing, and other connectorization issues. Also, active optical cables are indifferent to electromagnetic interference and provide relief from unintended ground loops, unlike many copper-based connector devices. Moreover, technicians do not have to worry about eye safety, unless there is a break in one of the optical fibers, thus the need for the open fiber control module in the active optical cable, as will be discussed in greater detail hereinbelow.

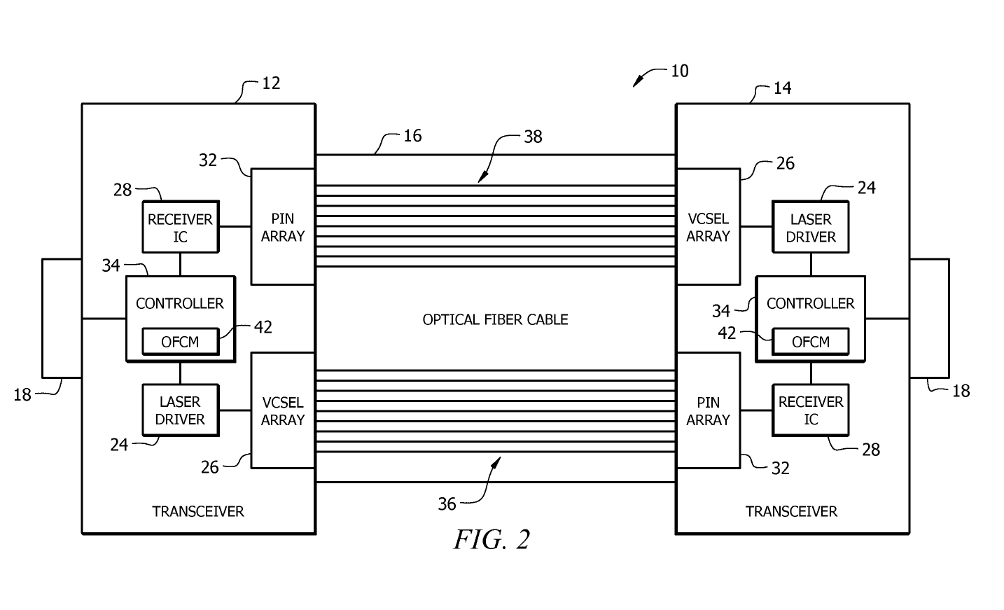

Referring now to FIG. 2, shown is a schematic view of an active optical cable 10 including an open fiber cable (OFC) module for detecting optical signal loss in the active optical cable, e.g., due to fiber breakage within the active optical cable, according to embodiments of the invention. As discussed hereinabove, the active optical cable 10 includes a first optical transceiver 12, a second optical transceiver 14 and an optical fiber or other transmission channel arrangement 16 coupled therebetween.

The first optical transceiver 12 and the second optical transceiver 14 each have a transmit or transmission side that can include a multi-channel optical transmitter, such as a laser driver 24 coupled to a vertical-cavity surface-emitting laser (VCSEL) array 26 corresponding to the number of transmission channels. Also, the first optical transceiver 12 and the second optical transceiver 14 each can have a receive or receiver side that includes a multi-channel receiver or receiver integrated circuit (IC) 28 coupled to an optical fiber pin array 32 corresponding to the number of transmission channels. In each optical transceiver, a general purpose (host) controller or processor 34 is coupled between the laser driver 24 and the receiver IC 28.

The transmit side of the first optical transceiver 12 is coupled to the receive side of the second optical transceiver 14 via a first plurality of optical fibers 36, such as an optical fiber ribbon cable or a stranded cable. Also, the transmit side of the second optical transceiver 14 is coupled to the receive side of the first optical transceiver 12 via a second plurality of optical fibers 38, such as an optical fiber ribbon cable or a stranded cable. The number of optical fibers in each plurality of optical fibers 36, 38 corresponds to the number of VCSELs in the corresponding VCSEL array 26 at one end of the optical fibers and the number of pins in the pin array 32 at the other end of the optical fibers.

In each of the first optical transceiver 12 and the second optical transceiver 14, the respective controller or processor 34, in general, controls the operation of the transceiver's transmit side, e.g., the laser driver 24, and the transceiver's receive side, e.g., the receiver IC 28. The controller 34 generally processes instructions, data and other information transmitted from and received by the respective transceiver, including electro-optical converted information to and from the copper-based data transmission system via the respective electrical connection portions 18. The controller or processor 34 also manages the movement of various instructions, data and other information to and from components within the respective optical transceiver.

According to embodiments of the invention, one or both optical transceivers includes an open fiber control (OFC) module 42. The OFC module 42 is configured to detect signal loss within the active optical cable 10, e.g., due to fiber breakage within the optical fiber arrangement 16, and to control the operation of the respective optical transceiver within which the OFC module 42 resides, as will be discussed in greater detail hereinbelow. The OFC module 42 can be included as part of the controller 34, as shown, e.g., as hardware, firmware or a combination of both. Alternatively, the OFC module 42 can be a stand alone controller IC coupled to the controller 34. Also, it should be understood that the controller 34 and the OFC module 42 can be a single component, e.g., a single controller integrated circuit (IC). The operation of the OFC module 42 will be discussed in greater detail hereinbelow.

One or more of the controller 34, the OFC module 42, the laser driver 24 and the receiver IC 28 can be comprised partially or completely of any suitable structure or arrangement, e.g., one or more integrated circuits. Also, it should be understood that each of the first optical transceiver 12 and the second optical transceiver 14 includes other components, hardware and software (not shown) that are used for the operation of other features and functions of the respective optical transceiver not specifically described herein.

Each of the first optical transceiver 12 and the second optical transceiver 14 can be partially or completely configured in the form of hardware circuitry and/or other hardware components within a larger device or group of components. Alternatively, at least a portion of each of the first optical transceiver 12 and the second optical transceiver 14 can be configured in the form of software, e.g., as processing instructions and/or one or more sets of logic or computer code. In such configuration, the logic or processing instructions typically are stored in a data storage device (not shown). The data storage device typically is coupled to a processor or controller, e.g., the controller 34. The processor or controller accesses the necessary instructions from the data storage element and executes the instructions or transfers the instructions to the appropriate location within the optical transceiver.

In operation, the OFC module 42 is configured to monitor and detect the power level of the optical signals being received by the corresponding receiver IC 28 in the optical transceiver from each of the optical transmission channels. If the OFC module 42 detects any signal loss to the receiver IC 28 in any of the transmission channels, e.g., due to fiber damage or breakage, the OFC module 42 is configured to instruct all transmitters on the corresponding transmission side of the optical transceiver to stop transmitting optical data signals. Once all optical transmission from the optical transceiver has been stopped, the OFC module 42 in the other (second) optical transceiver will detect the corresponding signal loss to the corresponding receiver IC 28 and therefore will instruct the corresponding transmitters on the transmission side of the other (second) optical transceiver to stop transmitting. Then, the optical transceivers will change their normal operating state to a polling state, e.g., automatically or upon specific instructions from their corresponding OFC module 42.

In the polling state, each of the transmitters within one or both of the optical transceivers, e.g., the transmitters within the optical transceiver whose OFC module 42 initially detected signal loss, periodically transmit a polling signal or other suitable optical transmission along their respective transmission channel. The OFC module 42 in the same optical transceiver monitors the corresponding receiver IC 28 for proper receipt of the polling signals, which indicates normal operation of all transmission channels in the active optical cable 10. When in the polling state, the OFC module 42 is configured to transfer any received polling signals from the receiver side of its optical transceiver to the transmission side of its optical transceiver. Therefore, in this manner, polling signals transmitted from a first optical transceiver to a second optical transceiver are received by the second optical transceiver, transferred to the transmitters in the second optical transceiver, and transmitted back to the first optical transceiver.

If the receiver IC 28 does not properly receive the polling signals, e.g., within a given time period, the optical transceiver remains in the polling state and, after a given period of time, the OFC module 42 instructs the transmitters to transmit new polling signals. The active optical cable 10 remains in the polling state until there is sufficient indication that the active optical cable 10 is operating properly, i.e., until the receiver IC 28 in the optical transceiver properly receives the polling signals, e.g., within a given time period. If the receiver IC 28 properly receives the polling signals, e.g., within a given time period, all transmission channels in the active optical cable 10 are deemed to be operating properly, and the OFC module 42 will instruct its corresponding transmission side to resume normal transmission. The receiver IC 28 in the other (second) optical transceiver will begin to receive proper transmission signals and, in response thereto, the OFC module 42 within the other (second) optical transceiver will instruct its corresponding transmission side to resume normal transmission. One or both of the optical transceivers then will change over from their polling state back to their normal operating state, e.g., automatically or upon specific instructions from the their corresponding OFC module 42.

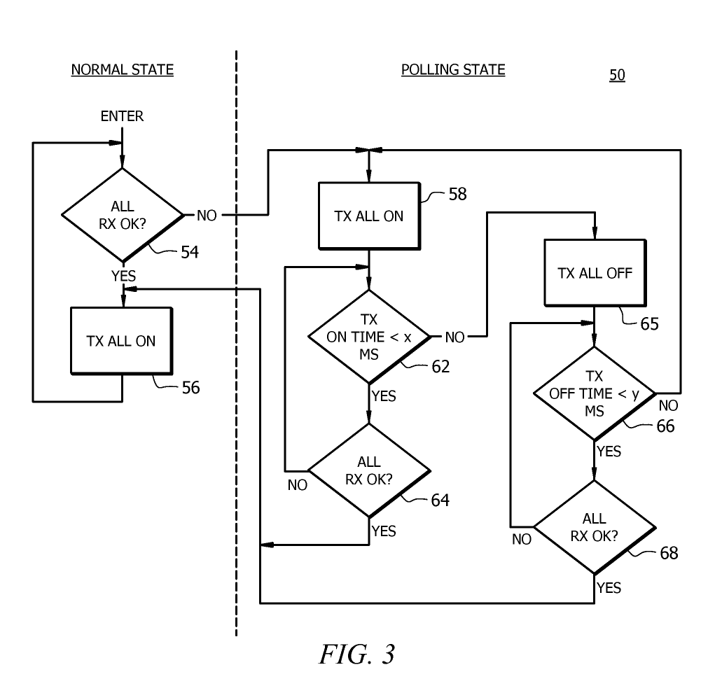

Referring now to FIG. 3, with continuing reference to FIG. 2, shown is a block diagram of a method 50 for detecting optical signal loss in an active optical cable, such as the active optical cable 10. As will be discussed in greater detail hereinbelow, the active optical cable 10 can operate in either a normal state or mode or a polling state or mode.

In a normal operating state or mode, the transmission side of the first optical transceiver 12 transmits optical information via a plurality of transmission channels, e.g., a first plurality of optical fibers 36, to the receiver side of the second optical transceiver 14, and the transmission side of the second optical transceiver 14 transmits optical information via another plurality of transmission channels, e.g., a second plurality of optical fibers 38, to the receiver side of the first optical transceiver 12. As part of the active optical cable operating in a normal state, the method 50 also includes a step 54 of detecting or monitoring the receiver side of each optical transceiver to determine whether or not the corresponding receiver IC 28 within the optical transceiver is receiving proper optical signal power levels in all transmission channels. As discussed hereinabove, such detecting or monitoring can be performed by the respective OFC module 42 and/or its associated controller 34 within the optical transceiver.

Also as part of the normal operating state, the method 50 also includes a step 56 in which all transmission channels within a given optical transceiver remain on, i.e., the transmission side of the (first) optical transceiver continues to transmit optical information to the receiver side of the other (second) optical transceiver in all available transmission channels therebetween. For example, in this transmission state, the laser driver 24 has normal bias and normal modulation. If the monitoring step 54 determines that the receiver IC 28 is receiving proper optical signal power levels in all transmission channels (Y), the step 56 is performed in that the transmission side of the (first) optical transceiver continues to transmit optical information in all transmission channels to the receiver side of the other (second) optical transceiver.

If the monitoring step 54 determines that the receiver IC 28 is not receiving proper optical signal power levels in all transmission channels (N), the active optical cable 10 switches to its polling state or mode. According to embodiments of the invention, one or both of the optical transceivers change over from their normal operating state to a polling state in any suitable manner, e.g., automatically or upon specific instructions from the corresponding OFC module 42 in the optical transceiver. In this manner, when both optical transceivers have shut down their respective transmission side, the optical transceivers (and thus the active optical cable 10) have effectively switched from their normal operating state to a polling state.

In general, the operation of the active optical cable 10 in the polling state works to turn off or stop the optical transmission from the laser driver 24 and VCSEL array 26, e.g., in response to the receiver IC 28 not receiving proper optical signal power levels in all transmission channels. As discussed hereinabove, the OFC module 42 monitors its respective receiver IC 28 for the receipt of proper optical signal power levels in all transmission channels to the receiver IC 28. If the OFC module 42 detects any signal loss in any of the transmission channels to the receiver IC 28, the OFC module 42 is configured to instruct all transmitters on the corresponding transmission side of the optical transceiver to stop transmitting. Once all transmission from the optical transceiver has been stopped, the OFC module 42 in the other (second) optical transceiver will detect signal loss in all transmission channels to its respective receiver IC 28 and, likewise, will instruct all transmitters on the corresponding transmission side of its optical transceiver to stop transmitting. Such operation is achieved during the polling state, as will be discussed in greater detail hereinbelow.

As part of the active optical 10 operating in the polling state, the method 50 includes a step 58 in which all transmission channels within a given optical transceiver get turned on, i.e., the transmission side of the (first) optical transceiver continues to transmit optical information to the receiver side of the other (second) optical transceiver in all available transmission channels therebetween.

The method 50 also includes a step 62 in which the transmitter-on time (i.e., TX ON) is checked to see if it has exceeded x milliseconds (ms), such as 50 milliseconds. Once the active optical cable 10 has switched to the polling state, the transmitters within one or both of the optical transceivers transmit a polling signal on their respective transmission channel for a given period of time. For example, the optical transceiver that transmits all polling signals or initially transmits some of the polling signals can be based on which OFC module 42 initially detected signal loss to its corresponding receiver IC 28. Alternatively, one or both optical transceivers can initiate polling signals automatically upon the active optical cable 10 switching to the polling state, or upon specific instructions from its corresponding OFC module 42.

The method 50 also includes a step 64 of detecting or monitoring the receiver side of the optical transceiver that transmitted the polling signals. The monitoring step 64 is performed during the polling signal transmission time period, i.e., as long as the transmitters are transmitting a polling signal, e.g., as along as the “TX on” time is less than x milliseconds (TX on time<x ms=Y).

When the active optical cable 10 is in the polling state, the OFC module 42 within a given optical transceiver detects or monitors its corresponding receiver IC 28 to determine whether the polling signals transmitted by the corresponding transmitters in the optical transceiver have been successfully transmitted back and received by the receiver IC 28, thereby indicating proper operation of all transmission channels in the active optical cable 10. The OFC module 42 is configured in such a way that, when the active optical cable 10 is in the polling state, the OFC module 42 passes any polling signals received by the corresponding receiver IC 28 to the corresponding transmitters for return transmission back to the optical transceiver that originated the transmission of the polling signals. In this manner, the active optical cable 10 is able to determine if all transmission channels within the active optical cable 10 are functioning properly.

If the monitoring step 64 determines that the receiver side of the optical transceiver that transmitted the polling signals has not properly received back all of the transmitted polling signals (N), the method 50 returns to the step 62, in which transmitters transmit a polling signal for a given period of time, e.g., for x milliseconds (ms). If the monitoring step 64 determines that the receiver side of the optical transceiver that transmitted the polling signals has properly received back all of the transmitted polling signals (Y), the method 50 returns to the step 56 of turning on all transmitters within the given optical transceiver. The receiver side of the other (second) optical transceiver subsequently will detect the proper receipt of all transmitted signals and, in response, the corresponding OFC module 42 will instruct all the transmitters in that (second) optical transceiver to turn on. The receiver side of the first optical transceiver then will detect the proper receipt of all transmitted signals thereto from the second optical transceiver. In this manner, the active optical cable 10 is functioning properly once again and has from the polling state back to its normal operating state.

The method 50 also includes a step 65 in which the transmission side of each optical transceiver stops all optical transmission to the other optical transceiver. According to the method 50, when the transmitters have finished transmitting a polling signal, i.e., after a period of x milliseconds (TX ON<x ms=N), the “TX all off” step 65 is performed, thus stopping the optical transmission of each transmitter in the optical transceiver to the corresponding receiver in the other optical transceiver. For example, the laser driver 24 within each optical transceiver has no bias and no modulation.

The method 50 also includes a step 66 in which the transmitter-off time (i.e., TX OFF) within a given optical transceiver is checked to see if the transmitter-off time has exceeded y milliseconds, such as 250 milliseconds. During this time in which the transmitters are turned off, i.e., i.e., as long as the transmitter-off time is less than y milliseconds (TX OFF<y ms=Y), the method 50 is performing a step 68 of detecting or monitoring the receiver side of the optical transceiver that is turned off. Once the transmitters are through being turned off, i.e., after a period of y milliseconds (TX OFF<y ms=N), the method 50 returns control back to the step 58 of all transmission channels within a given optical transceiver being turned on.

If the monitoring step 68 determines that the receiver side of the optical transceiver that transmitted the polling signals (during the polling signal transmission step 62) has not properly received back all of the transmitted polling signals (N), the method 50 returns to the step 66, in which transmitters are turned off for a given period of time, e.g., for y milliseconds (ms). If the monitoring step 68 determines that the receiver side of the optical transceiver that previously transmitted the polling signals has properly received back all of the transmitted polling signals (Y), the method 50 returns to the step 56 of turning on all transmitters within the given optical transceiver, and the active optical cable 10 returns to its normal operating state, e.g., as discussed hereinabove.

The process of transmitting polling signals for x milliseconds and then turning off the polling signal transmitters for y milliseconds can continue indefinitely if the transmitted polling signals are not properly received back by the optical transceiver. According to embodiments of the invention, the values for the time periods x and y can be adjusted, e.g., based on the configuration capability of the active optical cable 10 and its two optical transceivers, and/or eye safety requirements and/or active optical cable requirements.

As an example, during the normal operation of the active optical cable 10, assume that one of the optical fibers in the second plurality of optical fibers 38 breaks or becomes damaged. Because of the damage to the optical fiber, the optical signals being transmitted from the VCSEL array 26 in the second optical transceiver 14 to the pin array 32 in the first optical transceiver 12 along this optical fiber will not be received properly by the corresponding receiver in the receiver IC 28 in the first optical transceiver 12.

The OFC module 42 in the first optical transceiver 12 will detect the reduced power level of the optical signal to the receiver IC 28 by the damaged optical transmission channel. In general, the OFC module 42 in the first optical transceiver 12 then will instruct the transmitters in the first optical transceiver 12, e.g., the laser driver 24 and the VCSEL array 26 in the first optical transceiver 12, to shut down or stop their transmission to the receiver side of the second optical transceiver 14 along the first plurality of optical fibers 36.

In response to the transmitters in the first optical transceiver 12 being shut down, the OFC module 42 in the second optical transceiver 14 will detect reduced power levels of the optical signals transmitted to the receiver IC 28 in the second optical transceiver 14. In response to detecting the reduced power levels, the OFC module 42 in the second optical transceiver 14 will instruct the transmitters in the second optical transceiver 14, e.g., the laser driver 24 and the VCSEL array 26 in the second optical transceiver 14, to shut down or stop their transmission to the receiver side of the first optical transceiver 12 along the second plurality of optical fibers 38.

At this point, the optical transceivers and thus effectively the active optical cable 10 have switched from their normal operating state to their polling state. In the polling state, the OFC module 42 in the first optical transceiver 12, for example, instructs the transmitter side of the first optical transceiver 12 to send period polling signals to the receiver side of the second optical transceiver 14. Because the active optical cable 10 is now in the polling state, the OFC module 42 in the second optical transceiver 14 transfers all polling signals received by the receiver side of the second optical transceiver 14 to the transmission side of the second optical transceiver 14 for transmission back to the first optical transceiver 12. It should be understood that the polling signals can originate from either one or both optical transceivers.

As long as one of the optical fibers in the second plurality of optical fiber 38 is damaged (as is assumed in this example), the receiver side of the first optical transceiver 12 will not properly receive all polling signals. Accordingly, the OFC module 42 will continue to instruct polling signals to be transmitted periodically from the first optical transceiver 12 to the second optical transceiver 14, e.g., until the damaged optical fiber is repaired. Once the damaged optical fiber in the second plurality of optical fibers 38 is repaired, the receiver side of the first optical transceiver 12 will begin to receive all polling signals properly.

In general, once the receiver side of the first optical transceiver 12 begins to receive all polling signals properly, the OFC module 42 in the first optical transceiver 12 will instruct the transmission side of the first optical transceiver 12 to resume normal data signal transmission to the receiver side of the second optical transceiver 14. Once the OFC module 42 in the second optical transceiver 14 recognizes that the receiver side of the second optical transceiver 14 is properly receiving data signals from the first optical transceiver 12, the OFC module 42 in the second optical transceiver 14 will instruct the transmission side of the second optical transceiver 14 to resume normal data signal transmission to the receiver side of the first optical transceiver 12. In this manner, normal data signal transmission is restored throughout the active optical cable 10. Once normal data transmission has been restored throughout the active optical cable 10, both of the optical transceivers and thus effectively the active optical cable 10 switch from the polling state back to the normal operating state.

It will be apparent to those skilled in the art that many changes and substitutions can be made to the active optical cable apparatus and methods herein described without departing from the spirit and scope of the invention as defined by the appended claims and their full scope of equivalents.

1. An active optical cable, comprising:
a first optical transceiver having a first transmitter, a first receiver, and a first open fiber control module coupled between the first transmitter and the first receiver;
a second optical transceiver having a second transmitter, a second receiver, and a second open fiber control module coupled between the second transmitter and the second receiver;
at least one first optical transmission path coupled between the first transmitter and the second receiver; and
at least one second optical transmission path coupled between the second transmitter and the first receiver,
wherein the first open fiber control module is configured to detect an optical power level of an optical signal received by the first receiver via the second optical transmission path, and wherein the first open fiber control module is configured to control the operation of the first transmitter based on the detected optical power level of the optical signal received by the first receiver via the second optical transmission path, and
wherein the second open fiber control module is configured to detect an optical power level of an optical signal received by the second receiver via the first optical transmission path, and wherein the second open fiber control module is configured to control the operation of the second transmitter based on the detected optical power level of the optical signal received by the second receiver via the first optical transmission path.

2. The device as recited in claim 1, wherein at least one of the open fiber control modules is configured to switch the operation of the corresponding optical transceiver between a polling state and a normal operation state, wherein the open fiber control module switches the operation of the corresponding optical transceiver to the polling state in response to the open fiber control module detecting a reduction in optical power received by the receiver in the corresponding optical transceiver below a first optical power level.

3. The device as recited in claim 1, wherein at least one of the open fiber control modules is configured to switch the operation of the corresponding optical transceiver between a polling state and a normal operation state, wherein the open fiber control module switches the operation of the corresponding optical transceiver to the normal operation state in response to the open fiber control module detecting an increase in optical power received by the receiver in the corresponding optical transceiver above a first optical power level.

4. The device as recited in claim 1, wherein at least one of the open fiber control modules is configurable to operate the corresponding optical transceiver in a polling state in which the corresponding transmitter periodically transmits a first polling signal and the open fiber control module detects whether the corresponding receiver receives the first polling signal within a first time period, wherein the open fiber control module operates the corresponding optical transceiver in the polling state as long as the corresponding receiver does not receive the first polling signal within the first time period.

5. The device as recited in claim 4, wherein the open fiber control module is configurable to operate the corresponding optical transceiver in a normal operating state in response to the corresponding receiver receiving the first polling signal within the first time period.

6. The device as recited in claim 1, wherein the transmitter is a laser driver, and wherein the optical transceiver further comprises a laser array coupled between the laser driver and the optical transmission path.

7. The device as recited in claim 6, wherein the laser array is a VCSEL array.

8. The device as recited in claim 1, wherein the receiver is a receiver integrated circuit (IC), and wherein the optical transceiver further comprises a pin array coupled between the receiver IC and the optical transmission path.

9. The device as recited in claim 1, wherein the optical transceiver includes a controller coupled between the transmitter and the receiver, and wherein the open fiber control module is included as part of the controller.

10. The device as recited in claim 1, wherein the optical transmission path includes at least one of a plurality of optical fibers stranded together as an optical fiber stranded cable and a plurality of optical fibers coupled together as an optical fiber ribbon cable.

11. A method for controlling the operation of an active optical cable, wherein the active optical cable includes a first optical transceiver having a first transmitter, a first receiver, and a first open fiber control module coupled between the first transmitter and the first receiver, wherein the active optical cable includes a second optical transceiver having a second transmitter, a second receiver, and a second open fiber control module coupled between the second transmitter and the second receiver, and wherein the active optical cable includes at least one first optical transmission path coupled between the first transmitter and the second receiver and at least one second optical transmission path coupled between the second transmitter and the first receiver, comprising:
detecting, by the first open fiber control module, an optical power level of an optical signal received by the first receiver via the second optical transmission path;
controlling, by the first open fiber control module, the transmission of optical information by the first transmitter based on the detected optical power level of the optical signal received by the first receiver via the second optical transmission path;
detecting, by the second open fiber control module, an optical power level of an optical signal received by the second receiver via the first optical transmission path; and
controlling, by the second open fiber control module, the transmission of optical information by the second transmitter based on the detected optical power level of the optical signal received by the second receiver via the first optical transmission path.

12. The method as recited in claim 11, further comprising switching the operation of at least one optical transceiver between a polling state and a normal operation state, wherein the switching of the operation of the optical transceiver to the polling state occurs in response to at least one of the open fiber control modules detecting a reduction in optical power received by the corresponding receiver in the corresponding optical transceiver below a first optical power level.

13. The method as recited in claim 11, further comprising switching the operation of at least one optical transceiver between a polling state and a normal operation state, wherein the switching of the operation of the optical transceiver to the normal operation state occurs in response to the open fiber control module detecting an increase in optical power received by the corresponding receiver in the corresponding optical transceiver above a first optical power level.

14. The method as recited in claim 11, further comprising operating at least one optical transceiver in a polling state wherein the corresponding transmitter in the optical transceiver periodically transmits a first polling signal and the corresponding open fiber control module in the optical transceiver detects whether the corresponding receiver in the optical transceiver receives the first polling signal within a first time period, wherein the optical transceiver is operated in the polling state as long as the corresponding receiver in the optical transceiver does not receive the first polling signal within the first time period.

15. The method as recited in claim 14, further comprising switching the operation of the optical transceiver from the polling state to a normal operating state in response to the corresponding receiver in the optical transceiver receiving the first polling signal within the first time period.

16. The method as recited in claim 11, wherein at least one of the controlling steps includes instructing the corresponding transmitter to stop transmitting optical signals in response to the corresponding open fiber control module detecting a reduction in optical power received by the corresponding receiver below a first optical power level.

17. The method as recited in claim 11, wherein at least one of the controlling steps includes instructing the corresponding transmitter to transmit optical signals in response to the corresponding open fiber control module detecting an increase in optical power received by the corresponding receiver above a first optical power level.

18. The method as recited in claim 11, wherein at least one of the first and second transmitters is a laser driver, and wherein the optical transceiver further comprises a laser array coupled between the laser driver and the corresponding optical transmission path.

19. The method as recited in claim 18, wherein the laser array is a VCSEL array.

20. The method as recited in claim 11, wherein at least one optical transceiver includes a controller coupled between the corresponding transmitter and the corresponding receiver, and wherein the corresponding open fiber control module is included as part of the controller.
